(19) United States
(12) Patent Application Publication
(10) Pub. No.: US 2023/0278199 A1
(43) Pub. Date: Sep. 7, 2023

(54) SENSOR DEVICE FOR A GRIPPING SYSTEM, METHOD FOR GENERATING OPTIMAL GRIPPING POSES FOR CONTROLLING A GRIPPING DEVICE, AND ASSOCIATED GRIPPING SYSTEM

(71) Applicant: SCHUNK GmbH & Co. KG Spann- und Greiftechnik, Lauffen am Neckar (DE)

(72) Inventors: Christian Friedrich, Gundelsheim (DE); Harry Arnst, Heilbronn (DE)

(73) Assignee: SCHUNK GmbH & Co. KG Spann- und Greiftechnik, Lauffen am Neckar (DE)

(21) Appl. No.: 18/009,929

(22) PCT Filed: Jun. 11, 2021
(86) PCT No.: PCT/EP2021/065736

§ 371 Date: May 11, 2023

(30) Foreign Application Priority Data
Jun. 12, 2020 (DE) 10 2020 115 628.6

(51) Int. Cl. B25J 9/16

(52) U.S. Cl. CPC B25J 9/1612; B25J 9/1697

(57) ABSTRACT

A sensor apparatus for a gripping system, wherein the gripping system comprises a robot with a gripping device for handling objects and a robot or machine control for controlling the robot and/or the gripping device, and a method and associated gripping system.

### BACKGROUND

The invention relates to a sensor apparatus for a gripping system, wherein the gripping system comprises a robot, that is to say a manipulator with at least one degree of freedom such as, for example, an industrial robot, having a gripping device for handling objects and a robot or machine control for controlling the robot and the gripping device. The invention also relates to a method for generating gripping poses for a machine or robot control for controlling the robot and the gripping device for gripping objects and an associated gripping system. U.S. Pat. No. 9,002,098 B1 describes a robot-assisted visual perception system for determining a position and pose of a three-dimensional object. The system receives an external input for selecting an object to be gripped. The system also receives visual inputs from a sensor of a robot control that scans the object of interest. Rotation-invariant form features and appearance are extracted from the detected object and a set of object templates. A match between the scanned object and an object template is identified on the basis of form features. The match between the scanned object and the object template is confirmed using appearance features. The scanned object is then identified, and a three-dimensional pose of the scanned object of interest is determined. Based on the determined three-dimensional pose of the scanned object, the robot control is used to grip and manipulate the scanned object. The system operates on the basis of templates or rotation-invariant features in order to compare the sensor data with the model. These methods can preferably be used in contrast-rich scenes, but fail when there is insufficient contrast or geometric similarity between object classes. Model-free gripping is not shown. The semantic assignment of the object class is also not solved.

### SUMMARY OF THE INVENTION

The object of the present invention is to provide the production of optimal gripping poses. From these gripping poses, command sets for controlling the gripping device for gripping objects can then be produced in an advantageous manner on the part of the robot or machine. Both the gripping of known objects and the gripping of unknown objects should be possible. This object is achieved by a sensor apparatus having the features of claim 1.

Such a sensor apparatus allows, in particular, a rapid start-up of handling tasks such as pick & place without intervention in the robot or machine control, and without expert knowledge in the field of image processing and robotics. The sensor apparatus represents a largely autonomous unit with which suitable gripping poses can be generated. From these gripping poses, application-independent command sets for the robot or machine control can be generated on the part of the robot or machine.

The segmentation is a subarea of the digital image processing and of machine vision. The generation of regions related by content by combining adjacent pixels or voxels corresponding to a homogeneity criterion is termed segmentation.

As a service, the control interface provides the robot/machine controls in particular with semantic/numerical information about the objects contained in the image data and in particular the gripping poses.

A system with such a sensor apparatus consequently allows the gripping of known objects as well as the gripping of unknown objects on the basis of the generalized segmentation and gripping planning algorithm.

With the user interface, in particular the object models for the segmentation model, the gripping planning parameters for the gripping planning module and/or the control parameters for the control interface can be specified such as, for example, sensor parameterization, sensor and robot calibration, and/or the parameterization of gripping planning.

Further embodiments and advantageous designs of the invention are defined in the dependent claims.

The stated object is also achieved by a method according to claim 12 and by a gripping system according to claim 14.

Further details and advantageous embodiments of the invention can be found in the following description.

### BRIEF DESCRIPTION OF THE DRAWINGS

In the drawings:

FIG. 1: shows (a) sensor apparatus: pipeline; (b) training and deployment on device.

FIG. 2: shows a sensor apparatus prototype assembly.

FIG. 3: shows hardware architecture of a sensor apparatus.

### DETAILED DESCRIPTION

Ever shrinking batch sizes and increasing labor costs are major challenges in production engineering in high-wage countries. To allow them to be addressed, a modern automation system must be able to be quickly adapted to the new environmental conditions. In the following, a sensor apparatus is presented, which permits rapid start-up of handling tasks such as pick & place without programming.

The sensor apparatus, in particular, represents a computing unit that allows a suitable gripping pose for an object to be determined on the basis of gray value data, color data or 3D point cloud data (for example by mono or stereo camera systems). Suitable in this case means that the resulting grasp meets both certain quality criteria and does not lead to collisions between grippers, robots and other objects.

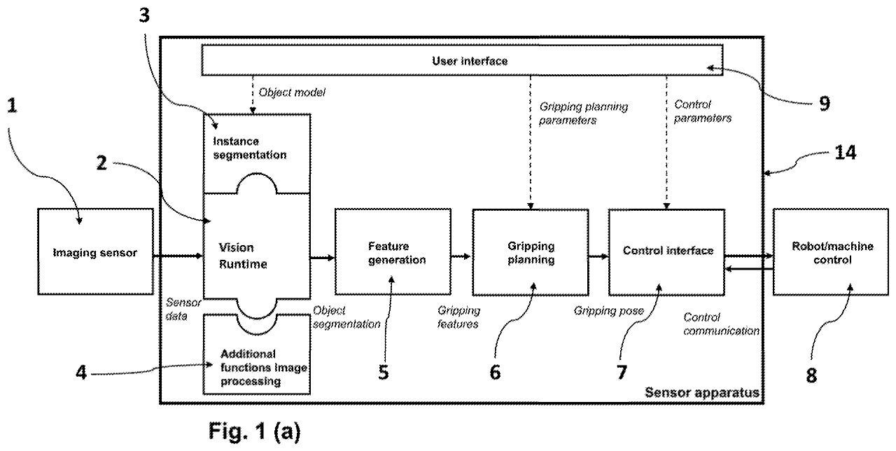

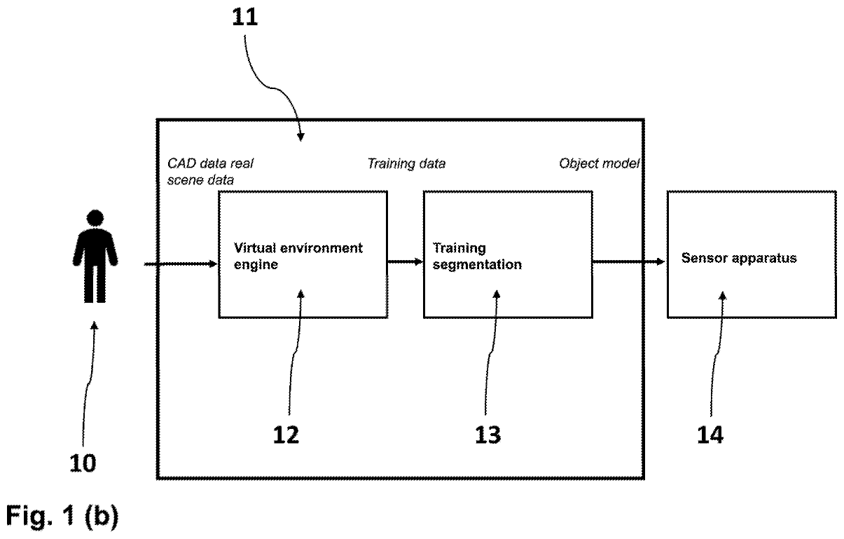

FIG. 1 (a) shows an example of the software architecture (pipeline) of the sensor apparatus, and FIG. 1 (b) shows the training and deployment.

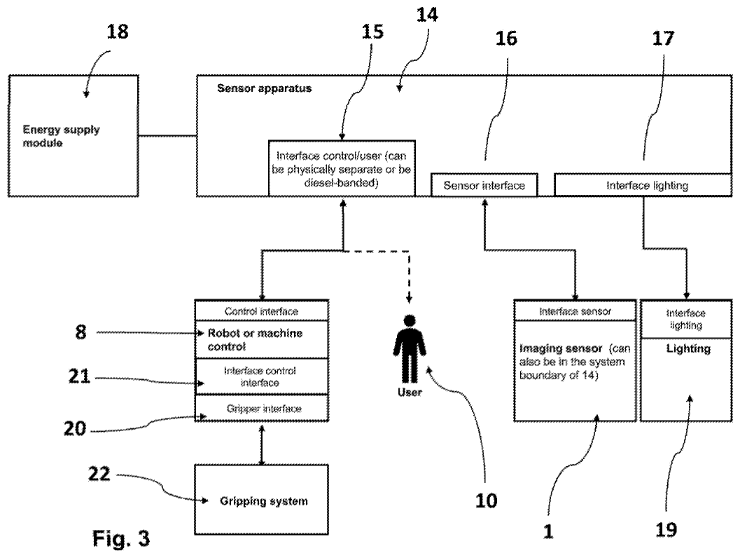

The camera system can be structurally integrated externally or directly into the sensor apparatus, which is clear from the hardware architecture according to FIG. 3. The gripping pose is forwarded to a control system, connected to the sensor apparatus, with a gripping device and manipulator (for example a robot), which then performs the gripping.

Any imaging sensors, or camera systems, as well as manipulator systems can be connected via, in particular, a physical Ethernet interface. The software characteristics of the respective subsystems (robot, camera) are abstracted via a metadata description and integrated function drivers.

The software architecture is termed a pipeline, since the result of process i represents the input variable for the process i+1. The individual objects are detected by an instance segmentation method from the image information provided by the sensor system. If other/further image processing functions are required, they can be made available to the overall system via the Vision Runtime. In this case, intrinsic functions can be developed, and finished runtime systems can be incorporated. The segmented objects (object envelope with class membership) represent the input variable for gripping planning. The gripping planner then detects suitable/desired gripping that is made available to the control interface for execution.

The process shown in FIG. 1 (b) describes the teaching and deployment of new gripping objects by way of example. On the basis of CAD and real scene data, training data are generated via the virtual environment engine. These comprise synthetic image data (2D or 3D) of the gripping objects in the overall scene and their annotation (ground truth of the objects) in a specified data format. A segmentation model is trained using the synthetic training data, which segmentation model can subsequently be downloaded via the user interface (web interface) of the sensor apparatus and made available to the segmentation method. The training takes place in particular outside the sensor apparatus on a powerful server, but can also be executed on the sensor apparatus.

Given the automatization of the individual steps, the time-consuming programming of the image processing and robot program is omitted. In particular, only the following processes must be parameterized/executed by end users:
Uploading CAD models (and/or real image data with a label) of the objects to the possibly external training server (via the user interface of the sensor apparatus)
Parameterizing the process (e.g., intermediate path points, deposit path points), the object models (such as z grip depth in the case of 2D image data, orientation, etc.) and the gripper models (such as gripping finger geometry) takes place via the user interface (web interface) of the sensor apparatus
Executing semi-automatic camera calibration and geometric registration between the camera and robot system.
Specifying the sequence and number of objects to be gripped with the functional component that is integrated in the robot control (task-oriented programming).

Customer-specific gripping problems can therefore be solved individually and without time-consuming and expensive programming effort. FIG. 3 presents an embodiment with the individual components.

The sensor apparatus forms the complete engineering process for automating a pick & place application. In this case, both 2D and 3D imaging sensors are considered, so that a solution that is suitable for hardware is obtained depending on the application. Also, no known system combines the various possibilities of gripping planning (model-free/model-based), so that it can be freely used for various applications. Known solutions are specified either for any object gripping or a specific one. By shifting the system boundaries, task-oriented programming of the pick & place task is possible for the first time. This means that the user only needs to indicate which object (semantics) he wishes to grip next.

In the following, the overall system is presented both in terms of the software and hardware. The software architecture and the system sequence will first be described. Based on this, the teaching and deployment of the sensor apparatus for new objects is presented before the hardware implementation is finally described.

### Software Architecture and System

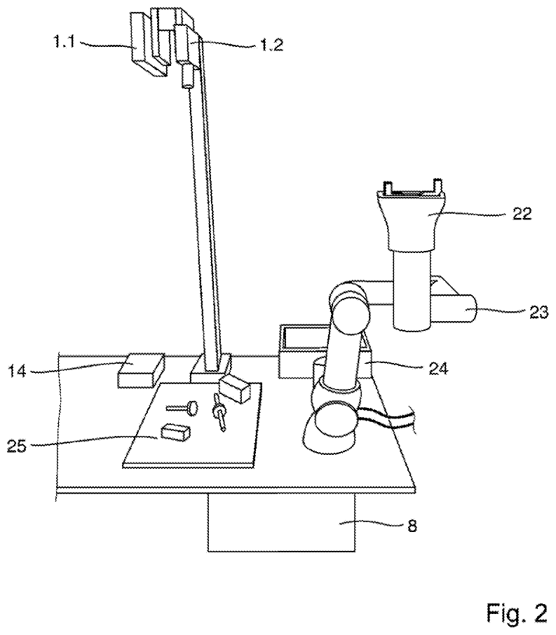

The pipeline with the process of sensor data acquisition up to communication with the control by the sensor apparatus 14 is shown in FIG. 3. In this case, the sensor data are obtained via, in particular, different imaging sensors 1.1 (2d) and 1.2 (3D) (see FIG. 2). In principle, any sensors can be integrated.

The data are processed by the Vision Runtime module 2. This uses the instance segmentation module 3 in normal operation (gripping planning). The output are the object envelopes together with the class association of the objects contained in the sensor data. So that the method can segment the objects in 3, a segmentation model must be trained beforehand via a data-driven method (see FIG. 1 (b)) that is integrated via the user interface 9. It is also possible to provide further image processing functions from the module additional functions 4 (for example quality inspection, barcode reading, etc.) of Vision Runtime 2.

In the feature generation module 5, the relevant gripping features are determined from the object segmentation. These then represent the basis for gripping planning in the gripping planning module 6.

Various methods for gripping planning are freely selectable by the user in the gripping planning module 6. In this case, model-based methods (one gripping or a plurality of grippings are specified by the user, and the system searches for this in the scene object) as well as model-free methods (the most optimum gripping in relation to gripping stability and quality is determined by the system) are possible in the gripping planning module 6. Various gripping systems (number of fingers, operating principle (clamping gripping and vacuum gripping) can also be set. This is configured via the user interface 9 via the gripping planning parameters.

As output, the planner provides a gripping pose and the gripping finger configuration in SE(3) via the control interface. Optionally, a list of all recognized objects together with class association and object envelopes can also be provided (in addition to the gripping pose).

The control interface 7 is used to communicate with the robot or machine control 8. This is designed as a client-server interface, wherein the sensor apparatus represents the server, and the control 8 represents the client. The interface 7 is based on a generally valid protocol, so that it can be used for various proprietary controls and their specific command sets. Communication takes place via TCP/IP or via a fieldbus protocol. A specific function block, which generates control-specific command sets, is integrated in the control module 8.

All the parameterization and configuration of the sensor apparatus is done via the user interface 9. This is mapped by a web server that runs locally on the sensor apparatus 14. The teaching of segmentation models is done on a possibly external training server, and the uploading of training data and downloading of the finished model is done via the user interface 9.

### Learning Phase and Deployment

The process for teaching the gripping objects and for deployment on the sensor apparatus is shown in FIG. 1 (b).

A training server 11 is available for teaching the segmentation model. This service can be carried out outside the sensor apparatus 14. The user 10 can provide the objects to be gripped as CAD data and as real scene data. On the basis of these data, various object scenes are generated in the virtual environment module 12 and made available as photosynthetic data to the training module 13. The time expenditure for the training data annotation can therefore be largely minimized. The data-driven segmentation algorithm is trained in the module 13. The output is a segmentation model that the user 10 incorporates on the sensor apparatus 14 via the user interface 9.

### Hardware Architecture

The hardware architecture and the embedding of the sensor apparatus 14 in the overall automation system is shown in FIG. 3.

The electrical energy is supplied to the sensor apparatus 14 via the energy supply module 18. The sensor apparatus, which functions as a server with respect to the control 8, represents the slave in the communication topology of the overall automation system. As the master, the control 8 integrates the gripping device 22 in terms of software and hardware by the provided fieldbus system. The gripping device 22 can also be integrated via a system control 21 if required by the architecture of the overall installation.

The sensor apparatus 14 is connected via the physical user interface 15 (Ethernet, for example) to a terminal (for example a PC) by the user 10. The software configuration then takes place via the interface 9 (web server).

The communication of the sensor apparatus 14 with the control 8 also takes place via an optionally physically separate or common interface 15 (Ethernet, fieldbus, for example). The communication takes place as already shown.

The communication to the imaging sensor takes place via a further, physically separate Ethernet interface 16. For example, GigE can be used in this case. An additional lighting module 19 can also be activated via the sensor apparatus interface 17 (digital output). The system boundary of 14 can also be expanded by the integration of 1 and 19, wherein the interfaces remain the same.

### Structural System Features

An image-processing sensor can be connected via a uniform interface (Ethernet) to the sensor apparatus that uses the sensor data.
A manipulator system (control and kinematics) can be connected to the sensor apparatus via a uniform interface (Ethernet, for example). The sensor apparatus as the server then provides the control as the client with the various services such as gripping pose, object positions, etc.
The user can connect to the sensor apparatus via the user interface (Ethernet) and set all necessary configurations and parameterizations via a web server.
The sensor apparatus represents a computer system that is either designed as a separate calculation box or can be integrated into a sub-component (gripping system, flange, for example). This can also be ported to corresponding external hardware as a software solution.
The sensor apparatus can be seamlessly integrated into modern automation architectures by the open interfaces for the control and the imaging sensor.

### Functional System Features

The sensor apparatus uses the visual sensor data and performs an instance segmentation of the previously defined gripping objects.
Further image processing functions can be integrated in Vision Runtime, so that, for example, special tasks such as quality checks or the like can be carried out.
The gripping planner can automatically determine predefined or suitable gripping on the basis of the results of the segmentation automatically for the objects.
The gripping pose is transformed directly into the selected robot coordinate system and transferred to the control.
By means of a semi-automatic calibration function, the image-processing sensor can be calibrated and geometrically registered with the manipulator system.
The sensor apparatus does not require system programming of the image processing system. Even the robot system only needs simple instructions, such as the programming of the deposit pose or specific logical and application-specific operations.
The individual gripping tasks are specified in task-oriented form by the user (pick(Object_X)) and are mapped in the respective control. The individual software modules are provided for this purpose.
The sensor apparatus can simply also return just the detected objects (without the planned grasp), since the interface is flexibly designed for the control. For example, the following services can be offered: getGraspPose( ), getObjects( ), getBestObject( ), hasObject(x), etc.
The sensor apparatus can be trained in advance for the gripping task on the basis of CAD data (e.g., stl) or real image data of the objects. Little/no real data is therefore required for a high gripping probability (>95%; value is application-dependent). If no semantics of the objects are required for the gripping task (for example the gripping of a specific object class), a generalized segmentation model that permits the segmentation of different and unknown objects can also be used. Training can take place on an external computer system.

### LIST OF REFERENCE SIGNS

1 Imaging sensor: Serves to record 2D or 3D data.
2 Vision Runtime: Software module that offers image processing algorithms.
3 Instance segmentation: Software algorithm that executes instance segmentation (segmentation between individual different and identical object classes, i.e. separation between all objects).
4 Additional functions of image processing: Software block that enables the embedding of additional image processing operations.
5 Feature generation: Software algorithm that calculates the features necessary for gripping planning (model-based, model-free).
6 Gripping planning module: Software algorithm that calculates a suitable gripping from features.
7 Control interface: Interface of the sensor apparatus for communication with 8.
8 Robot/machine control: Control of the robot.
9 User interface: Interface with the user for configuration and parameterization.
10 User: Operator of the sensor apparatus.
11 Training server: Generation of photosynthetic data or augmentation of data and training of 3. Super system of 12 and 13.
12 Virtual environment engine: Virtual rendering and physics engine for generating photosynthetic data and for augmentation of real image data.
13 Training segmentation: Training algorithm for 3.
14 Sensor apparatus: Super system of 1, 2, 3, 4, 5, 6, 7, 8 and 9.
15 Control/user interface: Physical Ethernet interface.
16 Interface sensor: Physical Ethernet interface.
17 Lighting interface
18 Energy supply module: External electrical power supply.
19 Lighting: Additional lighting for 1.
20 Gripper interface: Hardware and software interface for gripper.
21 Plant control interface: Hardware and software interface for plant.
22 Gripping device
23 Robot
24 Repository
25 Object to be gripped

1. A sensor apparatus for a gripping system, wherein the gripping system comprises a robot with a gripping device for handling objects, and a robot or machine control for controlling the robot and/or the gripping device, comprising:
a sensor interface for connection to an imaging sensor that can detect the object to be grasped,
a Vision Runtime module comprising a segmentation module that generates an object segmentation comprising an object envelope and a class membership by means of a segmentation model from the image data of the object to be grasped generated by the imaging sensor,
a feature generation module that determines relevant gripping features from the object segmentation,
a gripping planning module that generates a gripping pose for the gripping device from the gripping features,
a control interface that provides information about the gripping poses as a service to the robot/machine controls
a user interface with which object models for the segmentation model, gripping planning parameters for the gripping planning module and/or control parameters for the control interface can be specified, and
a control interface for communication with the robot or machine control for controlling the robot and/or the gripping device for handling the object to be gripped.

2. The sensor apparatus according to claim 1, characterized in that the acquired image data include gray value data, color data and/or 3D point cloud data.

3. The sensor apparatus according to claim 1, characterized in that the Vision Runtime module is designed such that the object models for the segmentation model are provided in a learning phase that is prior to object segmentation, so that the segmentation model is already available for object segmentation.

4. The sensor apparatus according to claim 3, characterized in that the object models and/or segmentation models are based on photosynthetic data, on CAD object data and/or on acquired image data of the object.

5. The sensor apparatus according to claim 1, characterized in that the segmentation model is based on a pixel-oriented and/or deep-learning method.

6. The sensor apparatus according to claim 1, characterized in that the Vision Runtime module is designed such that when a plurality of objects to be gripped is detected, object segmentation takes place for each individual one of the plurality of objects.

7. The sensor apparatus according to claim 1, characterized in that the specifiable gripping planning parameters comprise a selection of different gripping devices and/or the parameterization of the gripping process.

8. The sensor apparatus-according to claim 1, characterized in that the specifiable gripping planning parameters are based on a model-based method or a model-free method.

9. The sensor apparatus according to claim 1, characterized in that the specifiable gripping planning parameters comprise the specification of the sequence and/or number of objects to be gripped when object segmentation is carried out for a plurality of objects.

10. The sensor apparatus according to claim 1, characterized in that the sensor apparatus is integrated into a robot or machine control.

11. A method for generating command sets for a robot or machine control for controlling a robot and a gripping device for gripping objects, for running on a sensor apparatus, comprising the steps of:
generating image data of the object to be gripped with an imaging sensor,
generating an object segmentation comprising an object envelope and a class membership from the image data by means of a segmentation model,
determining relevant gripping features from the object segmentation,
creating a gripping pose from the relevant gripping features, and
generating command sets for the machine controller for controlling the robot and/or the gripping device from the gripping pose on the robot or machine side.

12. The method according to claim 11, characterized in that the object models are provided for the segmentation model in a learning phase that is carried out prior to object segmentation, so that the segmentation model is available in the object segmentation.

13. A gripping system having at least one imaging sensor, a sensor apparatus, a robot or machine control and a robot having a gripping device for handling objects to be gripped, wherein the sensor apparatus comprises
a sensor interface for connection to an imaging sensor that can detect the object to be grasped,
a Vision Runtime module comprising a segmentation module that generates an object segmentation comprising an object envelope and a class membership by means of a segmentation model from the image data of the object to be grasped generated by the imaging sensor,
a feature generation module that determines relevant gripping features from the object segmentation,
a gripping planning module that generates a gripping pose for the gripping device from the gripping features,
a control interface that provides information about the gripping poses as a service to the robot/machine controls
a user interface with which object models for the segmentation model, gripping planning parameters for the gripping planning module and/or control parameters for the control interface can be specified, and
a control interface for communication with the robot or machine control for controlling the robot and/or the gripping device for handling the object to be gripped,
and the system further comprising a computer program storage device readable by a machine, tangibly embodying a program of instructions executable by the machine to perform method steps for generating command sets for the robot or machine control for controlling the robot and the gripping device for gripping objects, said method steps comprising:
generating image data of the object to be gripped with an imaging sensor,
generating an object segmentation comprising an object envelope and a class membership from the image data by means of a segmentation model,
determining relevant gripping features from the object segmentation,
creating a gripping pose from the relevant gripping features, and
generating command sets for the machine controller for controlling the robot and/or the gripping device from the gripping pose on the robot or machine side.

14. A computer program storage device readable by a machine, tangibly embodying a program of instructions executable by the machine to perform method steps for generating command sets for a robot or machine control for controlling the robot and a gripping device for handling objects, said method steps comprising:
generating image data of the object to be gripped with an imaging sensor,
generating an object segmentation comprising an object envelope and a class membership from the image data by means of a segmentation model,
determining relevant gripping features from the object segmentation,
creating a gripping pose from the relevant gripping features, and
generating command sets for the machine controller for controlling the robot and/or the gripping device from the gripping pose on the robot or machine side.
